(19) United States
(12) Patent Application Publication
(10) Pub. No.: US 2012/0249266 A1
(43) Pub. Date: Oct. 4, 2012

(54) RF FILTER FOR ADJUSTING COUPLING AMOUNT OR TRANSMISSION ZERO

(75) Inventors: Dong-Yeon Lim, Incheon (KR); Guy-Yoil YI, Incheon (KR); Kyung-Min KO, Incheon (KR); Bong-Hoon KIM, Incheon (KR)

(73) Assignee: ACE TECHNOLOGIES CORPORATION, Incheon-si (KR)

(21) Appl. No.: 13/434,679

(22) Filed: Mar. 29, 2012

(30) Foreign Application Priority Data
Mar. 31, 2011 (KR) 10-2011-0029866
Mar. 31, 2011 (KR) 10-2011-0029883

(51) Int. Cl. H01P 1/20; H01P 7/06

(52) U.S. Cl. 333/202; 333/235

(57) ABSTRACT

An RF filter, e.g. RF cavity filter for adjusting coupling amount or transmission zero is disclosed. The RF filter includes a housing member in which cavities are defined by walls, resonators located in the cavities, a cover combined with an upper surface of the housing member, a first tuning element inserted into a first cavity of the cavities through the cover, and a second tuning element inserted into a second cavity of the cavities through the cover. Here, the first tuning element and the second tuning element are connected electrically.

### TECHNICAL FIELD

Example embodiment of the present invention relates to an RF filter, e.g. RF cavity filter for adjusting cross-coupling amount or transmission zero.

BACKGROUND ART

An RF cavity filter includes plural cavities, formed therein to pass only use frequency band of a signal, and is employed generally at a base station, etc. using comparative high power of a frequency signal.

FIG. 1 is a plan view illustration structure of a common RF cavity filter.

In FIG. 1, the RF cavity filter includes an input connector 100, an output connector 102, a housing member 104, cavities 110, 112, 114, 116, 118 and 120 defined by the housing member 104 and a wall, resonators 130, 132, 134, 136, 138 and 140 in each of the cavities 110, 112, 114 116, 118 and 120, and a coupling bar 160.

An RF signal inputted through the input connector 100 is provided to the cavity 110. Each of the cavities 110, 112, 114, 116, 118 and 120 and corresponding resonators 130, 132, 134, 136, 138 and 140 function as LC resonance elements, respectively.

The RF signal is delivered from one cavity to another cavity through a coupling window 150.

A resonance frequency of the filter is determined by size of the cavities and size of the resonators. A user may tune finely characteristics of the filter using tuning bolts which are not shown.

The skirt characteristic which means a slope of a boundary band in a pass band characteristic curve is important in view of the filter, and preferably should be formed sharply.

The skirt characteristic is improved according as order of the filter increases, i.e. the number of the cavities and the resonators increases. However, the skirt characteristic has trade-off relation with an insertion loss. That is, as the number of the cavities and the resonators increases, the skirt characteristic is enhanced but the insertion loss augments.

The filter forms a notch using cross coupling to improve the skirt characteristic with maintaining constant insertion loss.

The cross coupling means coupling between resonators which are not adjacent, e.g. coupling between a second resonator 132 and a fifth resonator 138. The cross coupling is realized generally through the coupling bar 160.

The coupling bar 160 is formed through a wall between the second cavity 122 and the fifth cavity 128, and is made up of a metal. The coupling bar 160 functions to deliver for example a signal of the second resonator 132 to the fifth resonator 138.

A hole for the coupling bar 160 is formed on the wall between the second cavity 122 and the fifth cavity 128, a dielectric layer is formed on an inner surface of the wall corresponding to the hole, and so the coupling bar 160 is not connected electrically to the wall.

However, this cross coupling structure may not adjust coupling amount between resonators. The coupling amount is determined by size of the coupling bar 160, and thus the coupling bar 160 should be replaced by new coupling bar having different size in case that desired coupling amount is not realized. In addition, the coupling amount may not be adjusted under the condition that the coupling bar 160 is set on the wall.

Moreover, the filter may not adjust transmission zero related to the skirt characteristic.

### DISCLOSURE

### Technical Problem

Example embodiment of the present invention provides an RF filter, for example RF cavity filter for adjusting cross coupling amount or transmission zero.

### Technical Solution

An RF filter according to one embodiment of the present invention includes a housing member in which cavities are defined by walls; resonators located in the cavities; a cover combined with an upper surface of the housing member; a first tuning element inserted into a first cavity of the cavities through the cover; and a second tuning element inserted into a second cavity of the cavities through the cover. Here, the first tuning element and the second tuning element are connected electrically.

An RF filter according to another embodiment of the present invention includes a housing member; a cover combined with an upper surface of the housing member; a first tuning area formed on one surface of the cover; a second tuning area formed on the one surface of the cover with separated from the first tuning area; a dielectric area formed between the first tuning area and the second tuning area on the one surface of the cover; and a third tuning element disposed on the dielectric area. Here, the first tuning area and the second tuning area are conductive areas.

An RF filter according to still another embodiment of the present invention includes a housing member; a cover combined with an upper surface of the housing member; a first tuning area formed on one surface of the cover; a second tuning area formed on the one surface of the cover with separated from the first tuning area; a dielectric area formed between the first tuning area and the second tuning area on the one surface of the cover; a first tuning element inserted into the housing member through the first tuning area of the cover; a second tuning element inserted into the housing member through the second tuning element of the cover; and a tuning sliding member disposed on the one surface of the cover. Here, a part of the tuning sliding member overlaps with the dielectric area.

### Advantageous Effects

An RF filter according to the present invention controls tuning elements inserted in corresponding cavities through a cover, thereby adjusting cross coupling amount or transmission zero. Specially, variable range of coupling coefficient and transmission zero may be considerably wide.

The RF filter according to the present invention adjusts capacitance between the tuning elements using a lumped element or a tuning sliding member under the condition that the tuning elements are inserted into corresponding cavities through the cover, and so cross coupling amount between corresponding resonators or transmission zero may be adjusted. Specially, a user may control the lumped element and the tuning sliding member outside to tune easily characteristics of the filter.

### BRIEF DESCRIPTION OF DRAWINGS

Example embodiments of the present invention will become more apparent by describing in detail example embodiments of the present invention with reference to the accompanying drawings, in which:

FIG. 1 is a plan view illustration structure of a common RF cavity filter;

FIG. 2 is a perspective view illustrating an RF filter according to a first embodiment of the present invention;

FIG. 3 is a view illustrating schematically a part of the RF filter according to one embodiment of the present invention;

FIG. 4 is a view illustrating structure of a cover and connection structure of tuning elements according to one embodiment of the present invention;

FIG. 5 is a view illustrating structure of a cover and connection structure of tuning elements according to another embodiment of the present invention;

FIG. 6 is a sectional view illustrating various tuning elements according to one embodiment of the present invention;

FIG. 7 is a view illustrating experimental result of coupling coefficient of the RF filter according to one embodiment of the present invention;

FIG. 8 is a view illustrating experimental result of transmission zero of the RF filter according to one embodiment of the present invention;

FIG. 9 is a view illustrating schematically structure of an RF filter according to a second embodiment of the present invention;

FIG. 10 is a perspective view illustrating an RF filter according to a third embodiment of the present invention;

FIG. 11 is a view illustrating structure of an RF filter according to a third embodiment of the present invention;

FIG. 12 is a top view illustrating a cover according to another embodiment of the present invention;

FIG. 13 is a perspective view illustrating an RF filter according to a fourth embodiment of the present invention;

FIG. 14 is a top view illustrating a cover of the RF filter in FIG. 13 according to one embodiment of the present invention; and

FIG. 15 is a view illustrating a cover of an RF filter according to a fifth embodiment of the present invention.

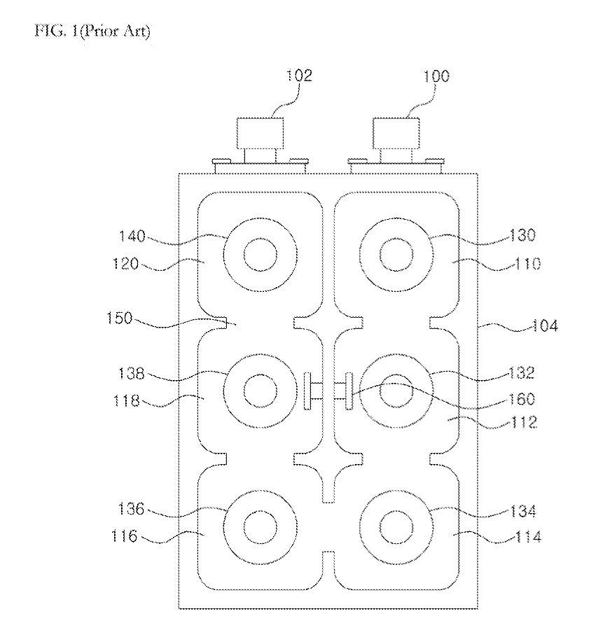

### DETAILED DESCRIPTION

Hereinafter, embodiments of the present invention will be described in detail with reference to accompanying drawings.

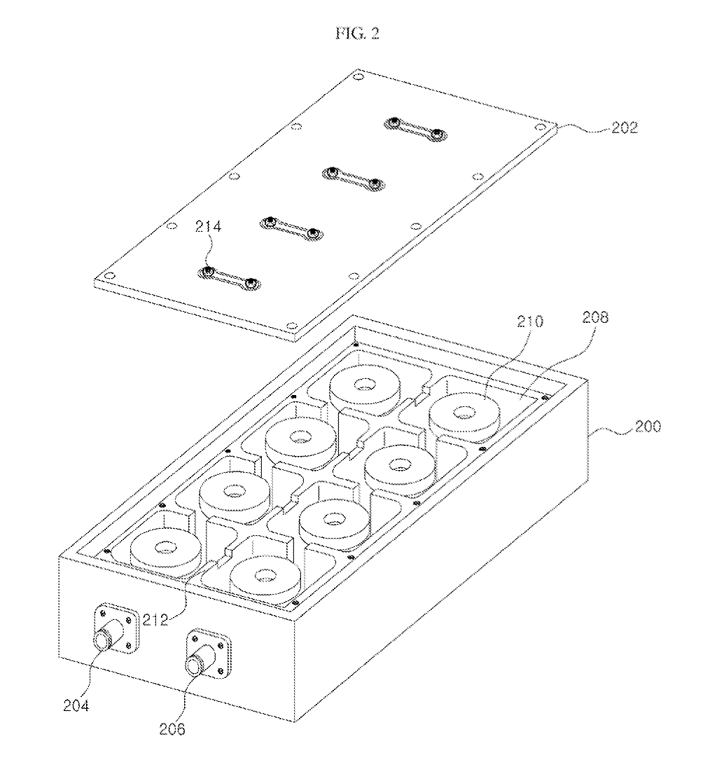

FIG. 2 is a perspective view illustrating an RF filter according to a first embodiment of the present invention.

In FIG. 2, the RF filter of the present invention is for example an RF cavity filter, and includes a housing member 200, a cover 202, an input connector 204, an output connector 206, cavities 208, resonators 210, walls 212 and tuning elements 214.

The housing member 200 protects elements in the RF filter, and blocks an electromagnetic wave. The housing member 200 may be formed by coating silver having high conductivity on an aluminum material.

The cover 202 is combined with an upper surface of the housing member 200, for example may be combined with the upper surface of the housing member 200 through a bolt, etc. The cover 202 may be formed by for example coating silver on aluminum material, and functions as a ground.

An RF signal is inputted through the input connector 204 and is outputted through the output connector 206. Here, the RF signal propagates through coupling windows formed in each of the cavities 208. Resonance of the RF signal is generated by the cavities 208 and the resonators 210, and the RF signal is filtered by the resonance.

The cavities 208 are defined by the walls 212, and each of the resonators 210 is formed in corresponding cavity 208. As the number of the resonator 210 and the cavity 208 increases, the skirt characteristic of the RF filter is enhanced but the insertion loss is deteriorated. Accordingly, the number of the resonator 210 and the cavity 208 are determined according to desired skirt characteristic and the insertion loss.

The resonator 210 may be a cylindrical resonator as shown in FIG. 2, but various resonators such as a disk type resonator, etc. may be employed as the resonator 210. The resonator 210 may be made up of a metal or dielectric member according to mode of the RF filter, i.e. TE mode or TM mode.

The tuning elements 214 are made up of for example a metal, are used to adjust cross coupling amount or transmission zero, and are inserted in corresponding cavity 208 under the condition that it combines with the cover 202. It is desirable that two tuning elements 214 face on the basis of the wall 212, i.e. a first tuning element is inserted in the cavity 208 located in the left of the wall 212 as shown in FIG. 2 and a second tuning element 214 is inserted in the cavity 208 located in the right of the wall 212.

In one embodiment of the present invention, the tuning elements 214 are tuning bolts, and are connected electrically each other under the condition that they combine with the cover 202. However, the tuning elements 214 are not connected electrically to the cover 202.

A user may adjust cross coupling amount or transmission zero by moving up and down the tuning element 214.

Hereinafter, a process of adjusting coupling amount or transmission zero using the tuning elements 214 and disposition of the tuning elements 214 will be described in detail with reference to accompanying drawings.

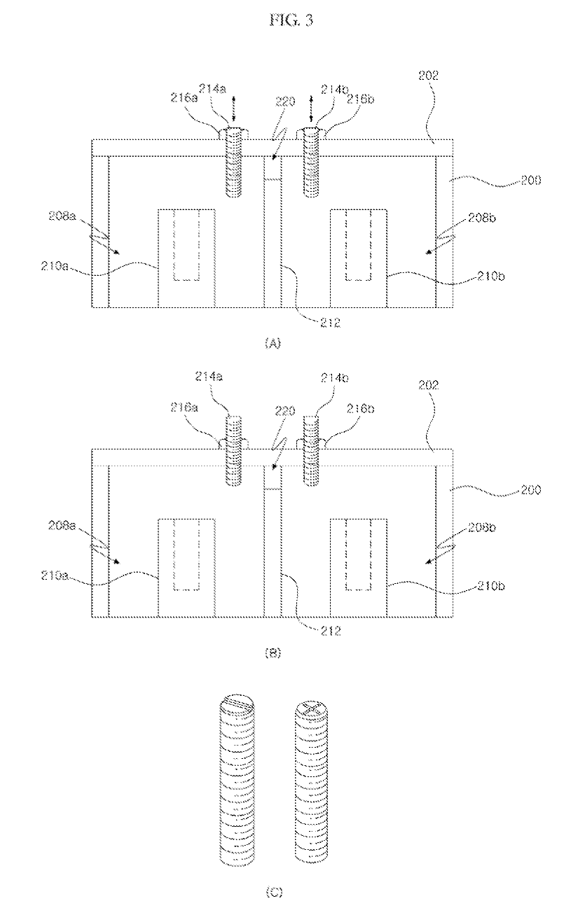

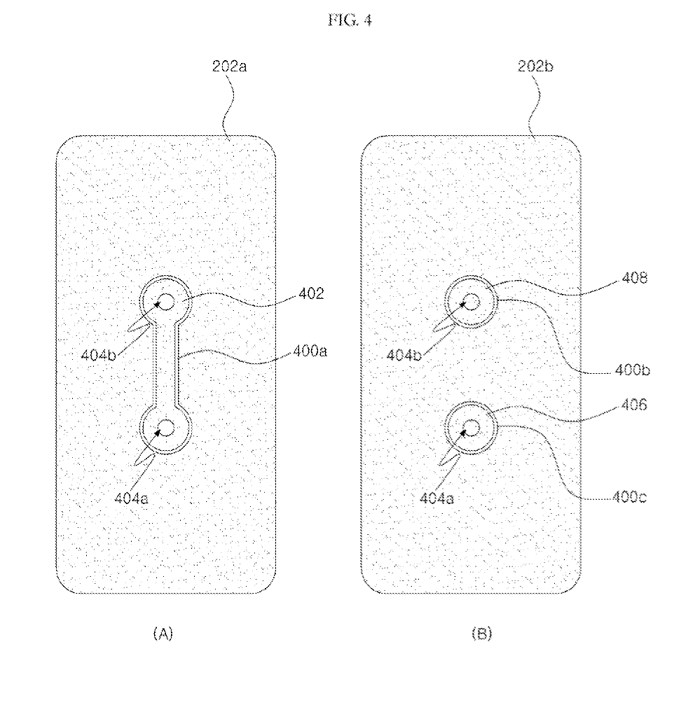

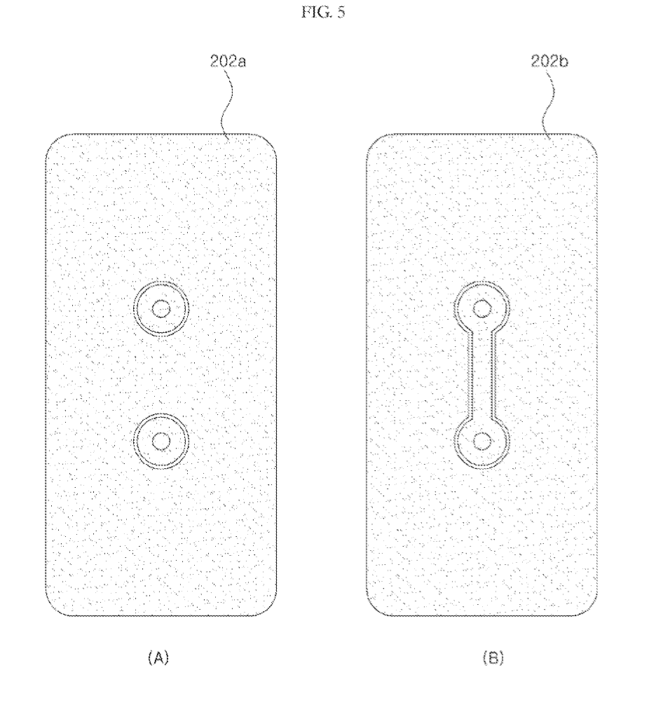

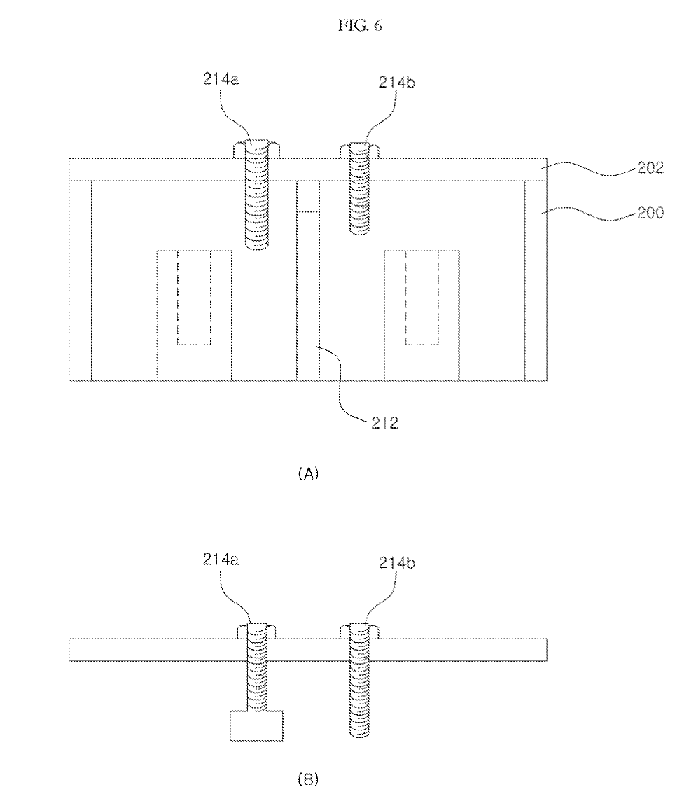

FIG. 3 is a view illustrating schematically a part of the RF filter according to one embodiment of the present invention, and FIG. 4 is a view illustrating structure of a cover and connection structure of tuning elements according to one embodiment of the present invention. FIG. 5 is a view illustrating structure of a cover and connection structure of tuning elements according to another embodiment of the present invention, and FIG. 6 is a sectional view illustrating various tuning elements according to one embodiment of the present invention.

In FIG. 3(A), a first resonator 210a is disposed in a first cavity 208a, a second resonator 210b is located in a second cavity 208b, and the wall 212 is disposed between the cavities 208a and 208b.

A first tuning element 214a is inserted into the first cavity 208a through the. cover 202, and combines with the cover 202 through a first nut 216a. A screw thread is formed on the first tuning element 214a, and so the first tuning element 214a moves up and down with combined with the cover 202 as shown in FIG. 3(B) in case that the first tuning element 214a rotates. It is desirable that a groove in which a rotation tool such as a driver, etc. is inserted is formed on an upper surface of the first tuning element 214a as shown in FIG. 3(C). The user may move the first tuning element 214a up and down by rotating the first tuning element 214a after the user inserts the rotation tool into the groove. As a result, insertion depth of the first tuning element 214a to the first cavity 208a is changed, and thus cross coupling amount or transmission zero may be adjusted.

A second tuning element 214b is inserted into a second cavity 208b through the cover 202, faces to the first tuning element 214a on the basis of the wall 212, and combines with the cover 202 through a second nut 216b. A screw thread is formed on the second tuning element 214b, and so the second tuning element 214b moves up and down with combined with the cover 202 as shown in FIG. 3(B) in case that the second tuning element 214b rotates. As a result, cross coupling amount or transmission zero is adjusted.

The tuning elements 214a and 214b are connected electrically. In one embodiment of the present invention, a first tuning area 402 and holes 404a and 404b may be formed on an upper surface 202a of the cover 202 as shown in FIG. 4(A), and a second tuning area 406, a third tuning area 408 and the holes 404a and 404b may be formed on a rear surface of the cover 202 as shown in FIG. 4(B). The first tuning element 214a is inserted into the first cavity 208a through the first hole 404a, and the second tuning element 214b is inserted into the second cavity 208b through the second hole 404b. Here, the tuning areas 402, 406 and 408 are conductive areas, and thus the tuning elements 214a and 214b are connected electrically through the first tuning area 402 formed on the upper surface 202a of the cover 202.

In case of etching the upper surface and the rear surface of the cover 202 formed by coating conductive material on a dielectric member according to the tuning areas 402, 406 and 408, the etching areas 400a, 400b and 400c are formed. No conductive material exists in the etching areas 400a, 400b and 400c. As a result, the tuning areas 402, 406 and 408 are separated electrically from the conductive material of the cover 202 by the etching areas 400a, 400b and 400c. Accordingly, the tuning elements 214a and 214b are connected electrically through the first tuning area 402, but are not connected electrically to the coating material of the cover 202, i.e. are not connected to the ground.

In another embodiment of the present invention, a second tuning area, a third tuning area and holes may be formed on the upper surface 202a of the cover 202 as shown in FIG. 5(A), and a first tuning area and the holes may be formed on the rear surface 202b of the cover 202 as shown in FIG. 5(B). The tuning elements 214a and 214b are connected electrically through the first tuning area formed on the rear surface 202b of the cover 202.

In still another embodiment of the present invention, a tuning area and holes may be formed on the upper surface 202a of the cover 202 as shown in FIG. 4(A), and a tuning area and holes may be formed on the rear surface 202b of the cover 202 as shown in FIG. 5(B). The tuning elements 214a and 214b are connected electrically by the tuning areas.

In still another embodiment of the present invention, a groove 220 is formed on an upper surface of the wall 212 to prevent electrical connection of the conductive material in the tuning area formed on the rear surface 202b of the cover 202 and the wall 212.

The user may adjust the cross coupling amount or the transmission zero in the above RF filter by changing the insertion depths of the tuning elements 214a and 214b to the cavities 208a and 208b. Here, insertion depths of the tuning elements 214a and 214b are the same or different. In addition, tuning of the tuning elements 214a and 214b when the coupling amount is adjusted may be different from that of the tuning elements 214a and 214b when the transmission zero is adjusted.

On the other hand, length, thickness and shape, etc. of the tuning elements 21a and 214b may be different. For example, the first tuning element 214a may have greater thickness than the second tuning element 214b as shown in FIG. 6(A), or the first tuning element 214a may have different shape and thickness compared with the second tuning element 214b. That is, the tuning elements 214a and 214b may be variously modified as long as the cross coupling amount or the transmission zero is adjusted.

Hereinafter, experimental result of coupling characteristics of the RF filter according to the present invention will be described in detail.

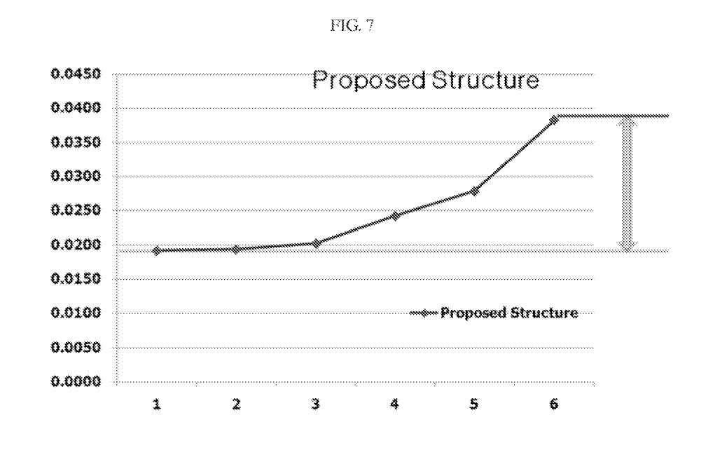

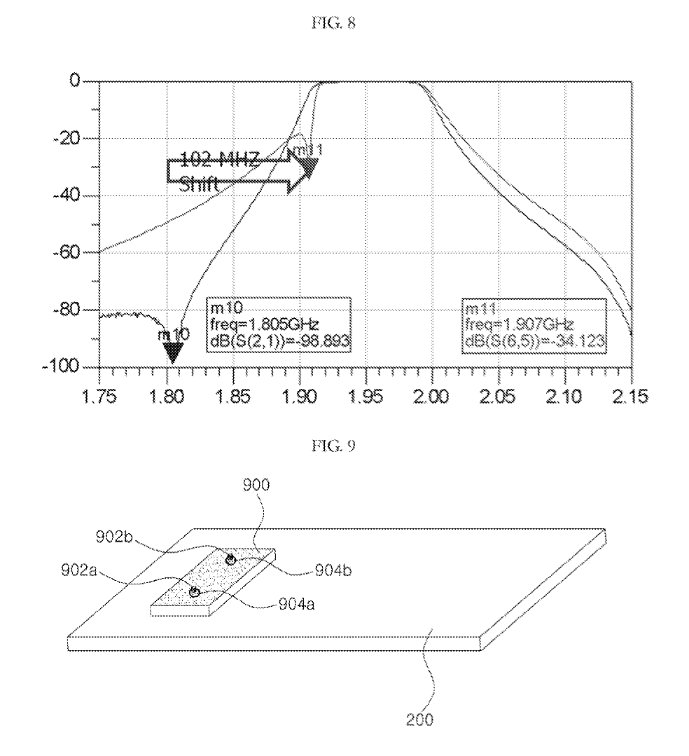

FIG. 7 is a view illustrating experimental result of coupling coefficient of the RF filter according to one embodiment of the present invention, and FIG. 8 is a view illustrating experimental result of transmission zero of the RF filter according to one embodiment of the present invention.

Referring to FIG. 7, it is verified that the coupling coefficient between the resonators 210 is changed by 0.019 (changed from 0.0191 to 0.0382). Coupling coefficient of the resonators in convention RF filter is changed by 0.0039. In other words, the RF filter of the present invention may be changed by approximately three times compared with the conventional RF filter. Accordingly, the RF filter of the present invention may tune the cross coupling amount between the resonators 210 in wide range.

In FIG. 8, it is verified that the transmission zero is changed from 1.805 GHz to 1.907 GHz. That is, the transmission zero is changed by 102 MHz. However, the transmission zero may be changed by above 102 MHz. Accordingly, the RF filter of the present invention may adjust skirt characteristic, etc. according to spec required for the RF filter.

FIG. 9 is a view illustrating schematically structure of an RF filter according to a second embodiment of the present invention. FIG. 9 does not show a housing member, resonators, etc.

In FIG. 9, the RF filter of the present embodiment includes a cover 200, a supporting member 900, tuning elements 902a and 902b and nuts 904a and 904b.

The supporting member 900 is formed on an upper surface of the cover 200, and may be formed by coating conductive material on a dielectric member.

A first tuning element 902a is inserted into corresponding cavity through the supporting member 900 and the cover 200, and a second tuning element 902b is inserted into corresponding cavity through the supporting member 900 and the cover 200. Since an upper surface of the supporting member 900 is coated with conductive material, the tuning elements 902a and 902b are connected electrically. However, the tuning elements 902a and 902b are not connected electrically to the cover 202 because a base of the supporting member 900 is made up of dielectric member.

The tuning elements 902a and 902b are fixed to the supporting member 900 by the nuts 904a and 904b.

In brief, in the RF filter, the supporting member 900 is formed on the cover 200, and the tuning elements 902a and 902b are inserted into corresponding cavities through the supporting member 900 and the cover 200. Accordingly, unlike the RF filter in the first embodiment where the upper surface of the cover is etched, the upper surface of the cover may not be etched in the RF filter of the present embodiment.

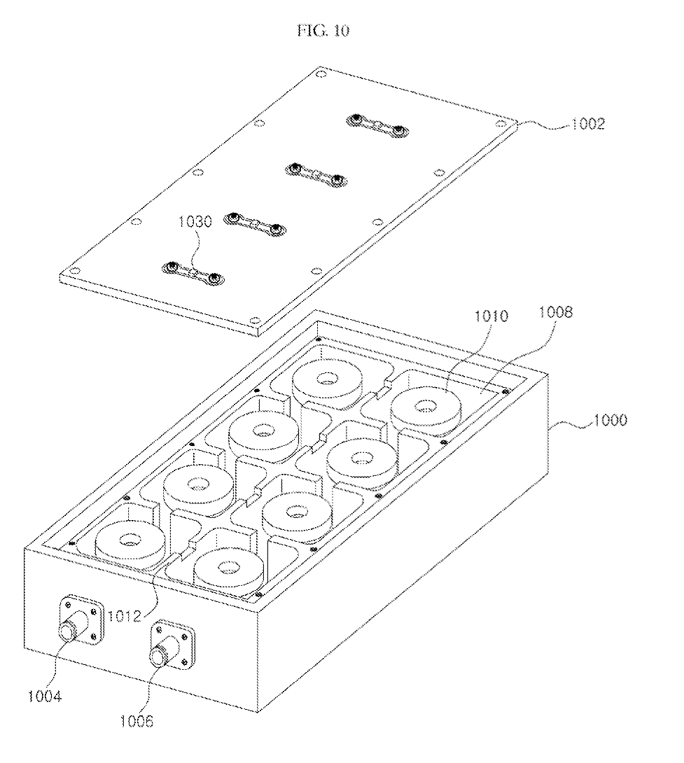

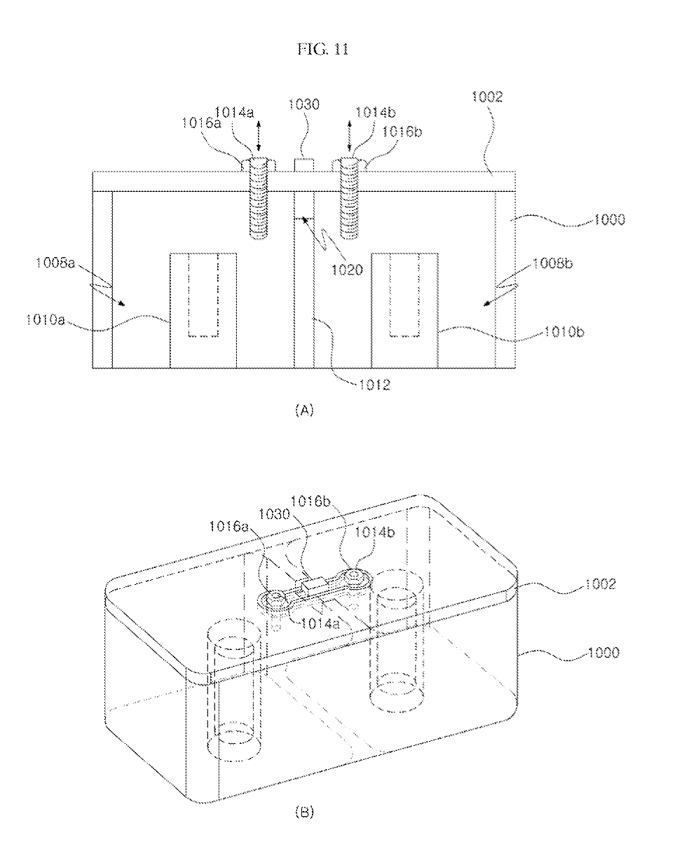

FIG. 10 is a perspective view illustrating an RF filter according to a third embodiment of the present invention.

In FIG. 10, the RF filter of the present invention is for example an RF cavity filter, and includes a housing member 1000, a cover 1002, an input connector 1004, an output connector 1006, cavities 1008, resonators 1010, walls 1012 and a third tuning element 1030.

Since the housing member 1000, the cover 1002, the input connector 1004, the output connector 1006 the cavities 1008, the resonators 1010 and the walls 1012 are the same in FIG. 2, any further description concerning the same elements will be omitted.

The third tuning element 1030 is for example a metal, is used for adjusting cross coupling amount or transmission zero, and is disposed on an upper surface of the cover 1002.

In one embodiment of the present invention, the third tuning element 1030 may be a lumped element such as a capacitor, an inductor, etc.

Hereinafter, a process of adjusting coupling amount or transmission zero using the third tuning element 1030 and structure of the RF filter will be described in detail with reference to accompanying drawings.

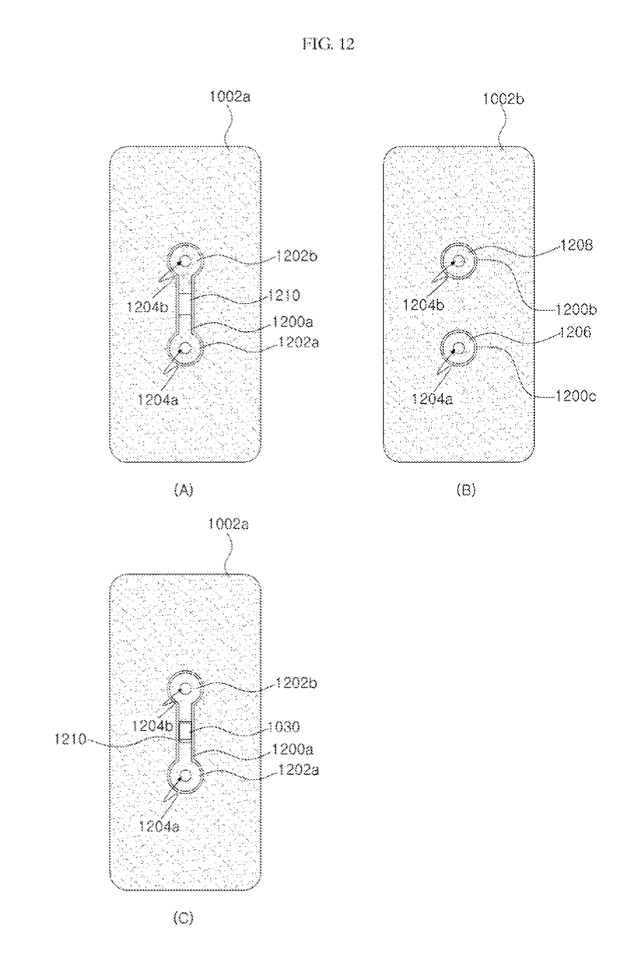

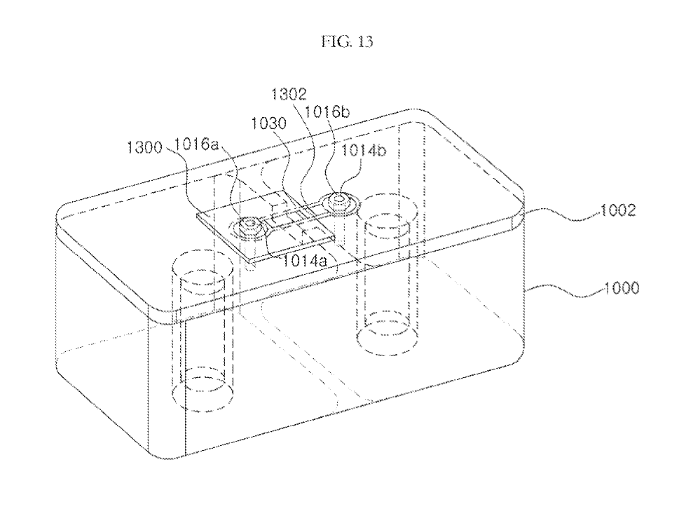

FIG. 11 is a view illustrating structure of an RF filter according to a third embodiment of the present invention, and FIG. 12 is a top view illustrating a cover according to another embodiment of the present invention.

In FIG. 12(A), an etching area 1200a, a first tuning area 1202a, a second tuning area 1202b and a dielectric area 1210 are formed on an upper surface 1002a of the cover 1002.

In FIG. 12(B), etching areas 1200b and 1200c, a third tuning area 1206 and a fourth tuning area 1208 are formed on a rear surface 1002b of the cover 1002.

The tuning areas 1202a, 1202b, 1206 and 1208 are conductive areas, for example are coated by conductive material.

A first hole 1204a is formed in the first tuning area 1202a and the third tuning area 1206, and a second hole 1204b is formed in the second tuning area 1202b and the fourth tuning area 1208. A first tuning element 1014a as for example a conductor is inserted into a first cavity 1008a through the first tuning area 1202a and the third tuning area 1206 of the cover 1002 as shown in FIG. 11. A second tuning element 1014b as for example a conductor is inserted into a second cavity 1008b through the second tuning area 1202b and the fourth tuning area 1208 of the cover 1002.

In one embodiment of the present invention, screw thread is formed on outer surfaces of the first tuning element 1014a and the second tuning element 1014b. Accordingly, the first tuning element 1014a or the second tuning element 1014b may move up and down with supported by the cover 1002 in case that the first tuning element 1014a or the second tuning element 1014b rotates.

The first tuning element 1014a is fixed to the upper surface 1002a of the cover 1002 by a first nut 1016a, and the second tuning element 1014b is fixed to the upper surface 1002a of the cover 1002 by a second nut 1016b.

The dielectric area 1210 locates between the first tuning area 1202a and the second tuning area 1202b in the first etching area 1200a. Here, the first tuning area 1200a and the second tuning area 1200b are separated physically; but coupling is generated between the first tuning area 1200a and the second tuning area 1200b by the dielectric area 1210. That is, certain capacitance is formed between the first tuning area 1202a and the second tuning area 1202b. Accordingly, the first tuning element 1014a and the second tuning element 1014b are connected electrically through a coupling method, and so cross coupling generates between the resonators 1010a and 1010b in the cavities 1008a and 1008b where the tuning elements 1014a and 1014b are inserted.

In one embodiment of the present invention, the third tuning element 1030 as a lumped element is disposed in the dielectric area 1210. As a result, the capacitance between the first tuning area 1202a and the second tuning area 1202b is changed by the third tuning element 1030, e.g. a capacitor, and thus cross coupling amount between the resonators 1010a and 1010b or transmission zero is changed. In other words, the cross coupling amount between the resonators 1010a and 1010b or the transmission zero may vary depending on the third tuning element 1030 disposed on the dielectric area 1210 as shown in FIG. 12(C). Accordingly, the user may select properly the third tuning element 1030 to realize desired cross coupling amount or transmission.

In one embodiment of the present invention, to adjust the cross coupling amount or the transmission zero, the user may change only the third tuning element 1030 under the condition that he fixes the first tuning element 1014a and the second tuning element 1014b, or change the first tuning element 1014a or the second tuning element 1014b as well as the third tuning element 1030. Here, the first tuning element 1014a or the second tuning element 1014b moves up and down.

In another embodiment of the present invention, a groove 1020 may be formed on an upper surface of the wall 1012 to prevent electrical connection of conductive material of the tuning area 1206 and 1208 formed on the rear surface 1002b of the cover 1002 and the wall 1012.

The dielectric area 1210 may be formed by removing coating material of the cover 1002, i.e. the dielectric member of the cover 1002 is exposed.

In short, the RF filter of the present embodiment may adjust the cross coupling amount or the transmission zero by using the third tuning element 1030.

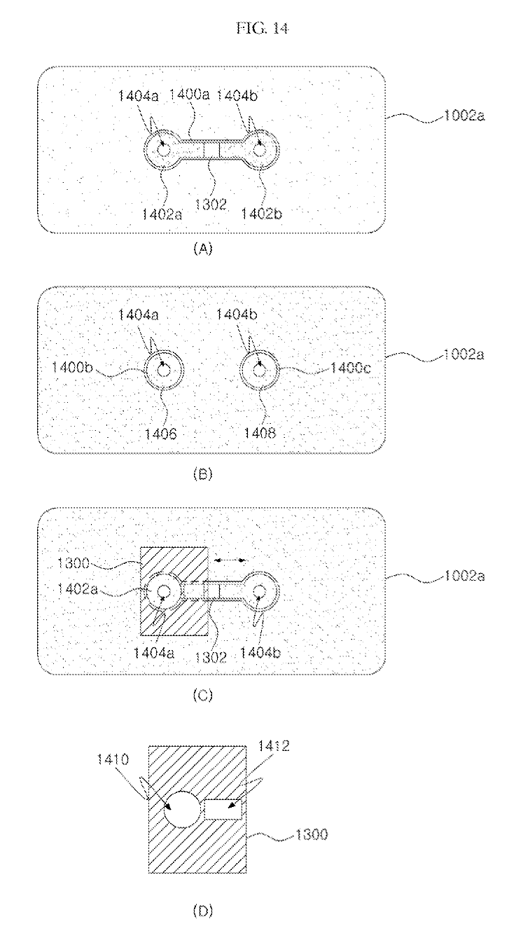

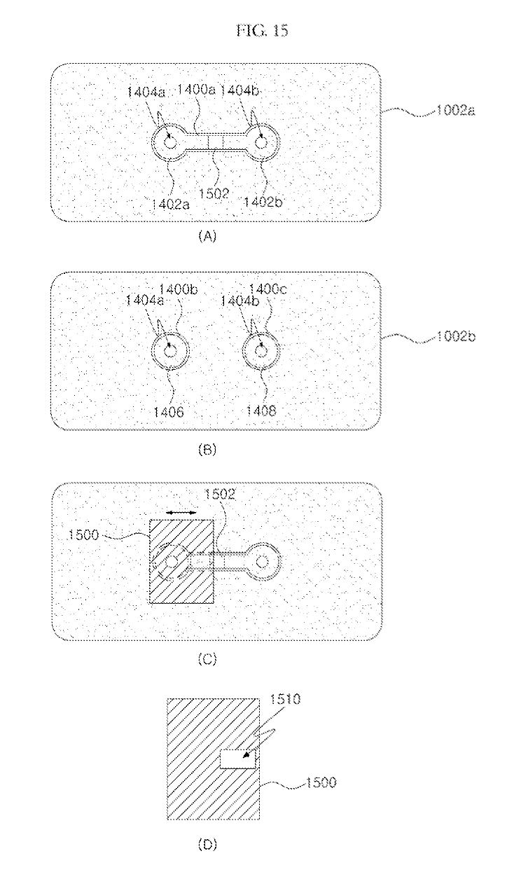

FIG. 13 is a perspective view illustrating an RF filter according to a fourth embodiment of the present invention, and FIG. 14 is a top view illustrating a cover of the RF filter in FIG. 13 according to one embodiment of the present invention.

In FIG. 13, the RF filter of the present embodiment includes a housing. member 1000, a cover 1002, a first tuning element 1014a, a second tuning element 1014b, a first nut 1016a, a second nut 1016b and a tuning sliding member 1300 as a dielectric member.

In FIG. 14, an etching area 1400a, a first tuning area 1402a, a second tuning area 1402b and a dielectric area 1302 are formed on an upper surface 1002a of the cover 1002.

In FIG. 14(B), etching areas 1400b and 1400c, a third tuning area 1406 and a fourth tuning area 1408 are formed on a rear surface 1002b of the cover 1002.

The tuning areas 1402a, 1402b, 1406 and 1408 are conductive areas, for example are coated with conductive material.

A first tuning element 1014a is inserted into a first cavity 1008a through the first tuning area 1402a and the third tuning area 1406 of the cover 1002, and a second tuning element 1014b is inserted into a second cavity 1008b through the second tuning area 1402b and the fourth tuning area 1408 of the cover 1002.

The first tuning element 1014a is fixed to the upper surface of the cover 1002 by the first nut 1016a, and the second tuning element 1014b is fixed to the upper surface 1002a of the cover 1002 by the second nut 1016b.

The dielectric area 1302 locates between the first tuning area 1402a and the second tuning area 1402b in the first etching area 1400a. The first tuning area 1400a and the second tuning area 1400b are separated physically, but coupling generates between the first tuning area 1400a and the second tuning area 1400b.

In one embodiment of the present invention, two holes 1410 and 1412 may be formed on the tuning sliding member 1300 as shown in FIG. 14(D). The tuning sliding member 1300 is fixed by the first tuning element 1014a inserted into the first cavity 1008a through the first hole 1410 and the cover 1002 or the first nut 1016a, and may shift left and right as shown in FIG. 14(C) under the condition that it is fixed by the first tuning element 1014a or the first nut 1016a. An end part of the tuning sliding member 1300 overlaps on the dielectric area 1302, and capacitance between the tuning elements 1402a and 1402b is varied according to the overlap area. As a result, cross coupling amount between corresponding resonators or transmission zero may be changed. The tuning sliding member 1300 may shift front and rear direction. The tuning sliding member 1300 may be fixed through various methods after it is shifted to desired position.

In brief, the RF filter of the present invention may adjust the cross coupling amount between corresponding resonators or the transmission zero by controlling the overlap area of the tuning sliding member 1300 disposed on the upper surface 1002a of the cover 1002 and the dielectric area 1302.

In above description, the tuning sliding member 1300 has rectangular shape, but may have variously shapes as long as it is overlapped on the dielectric area 1302 to change the capacitance between the tuning elements 1402a and 1402b.

The tuning sliding member 1300 is disposed on the position corresponding to the first tuning element 1014a in FIG. 14, but may be disposed on the position corresponding to the second tuning element 1014b.

The tuning elements 1014a and 1014b may move up and down through their rotation.

FIG. 15 is a view illustrating a cover of an RF filter according to a fifth embodiment of the present invention.

In FIG. 15, a tuning sliding member 1500 is disposed on an upper surface 1002a of a cover 1002 in the RF filter of the present embodiment. Unlike the fourth embodiment where the tuning sliding member 1300 is supported by the first tuning element 1014a, the tuning sliding member 1500 is disposed on the first tuning element 1014a as shown in FIG. 15(C). The tuning sliding member 1500 overlaps on a dielectric area 1502, and so cross coupling amount between corresponding resonators or transmission zero is changed.

A hole 1510 may be formed on the tuning sliding member 1500 as shown in FIG. 15(D).

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An RF filter comprising:
a housing member in which cavities are defined by walls;
resonators located in the cavities;
a cover combined with an upper surface of the housing member;
a first tuning element inserted into a first cavity of the cavities through the cover; and
a second tuning element inserted into a second cavity of the cavities through the cover,
wherein the first tuning element and the second tuning element are connected electrically.

2. The RF filter of claim 1, wherein the cover is formed by coating conductive material on a dielectric member, a first tuning area is formed by etching a part of one surface of the cover, a second tuning area and a third tuning area are formed by etching a part of other surface facing to the one surface of the cover,
the first tuning element is inserted into the first cavity through the first tuning area and the second tuning area, the second tuning element is inserted into the second cavity through the first tuning area and the third tuning area, the first tuning element and the second tuning element are connected electrically by conductive material in the first tuning area.

3. The RF filter of claim 2, wherein the first tuning clement and the second tuning element move up and down of the cover, and coupling amount between a first resonator inserted into the first cavity and a second resonator inserted into the second cavity or transmission zero is adjusted according to movement of the first tuning element and the second tuning element.

4. The RF filter of claim 1, further comprising:
the wall configured to separate the first cavity from the second cavity,
wherein the cover is formed by coating conductive material on a dielectric member, a tuning area is formed by etching a part of a rear surface of the cover, a groove is formed on an upper surface of the wall, and the tuning area corresponds to the groove.

5. The RF filter of claim 1, wherein the first tuning element is fixed to an upper surface of the cover by a first nut, and the second tuning element is fixed to the upper surface of the cover by a second nut.

6. The RF filter of claim 1, wherein thickness or length of the first tuning element is different from that of the second tuning element.

7. The RF filter of claim 1, further comprising:
a supporting member formed on an upper surface of the cover,
wherein the first tuning element is inserted into the first cavity through the supporting member and the cover, the second tuning element is inserted into the second cavity through the supporting member and the cover, the supporting member is formed by coating conductive material on a dielectric member, and the first tuning element and the second tuning element are connected electrically through the conductive material of the supporting member.

8. An RF filter comprising:
a housing member;
a cover combined with an upper surface of the housing member;
a first tuning area formed on one surface of the cover;
a second tuning area formed on the one surface of the cover with separated from the first tuning area;
a dielectric area formed between the first tuning area and the second tuning area on the one surface of the cover; and
a third tuning element disposed on the dielectric area,
wherein the first tuning area and the second tuning area are conductive areas.

9. The RF filter of claim 8, further comprising:
cavities defined by walls in the housing member;
resonators located in the cavities;
a third tuning area formed on other surface facing to the one surface of the cover;
a fourth tuning area formed on the other surface of the cover with separated from the third tuning area;
a first tuning element inserted into a first cavity of the cavities through the first tuning area and the third tuning area of the cover; and
a second tuning element inserted into a second cavity of the cavities through the second tuning element and the fourth tuning element of the cover,
wherein the cover is formed by coating conductive material on a dielectric member, the third tuning element is an lumped element, the first tuning area and the second tuning area are formed by etching a part of the one surface of the cover, the third tuning area and the fourth tuning area are formed by etching a part of the other surface of the cover, cross coupling amount between corresponding resonators or transmission zero depends on the third tuning element.

10. The RF filter of claim 9, wherein each of the first tuning element and the second tuning element is a bolt, the first tuning element is fixed to an upper surface of the cover by a first nut, and the second tuning element is fixed to the upper surface of the cover by a second nut,
the first tuning element and the second tuning element are disposed symmetrically on the basis of specific wall, a groove is formed on an upper surface of the wall, and the first tuning element and the second tuning element move up and down.

11. An RF filter comprising:
a housing member;
a cover combined with an upper surface of the housing member;
a first tuning area formed on one surface of the cover;
a second tuning area formed on the one surface of the cover with separated from the first tuning area;
a dielectric area formed between the first tuning area and the second tuning area on the one surface of the cover;
a first tuning element inserted into the housing member through the first tuning area of the cover;
a second tuning element inserted into the housing member through the second tuning element of the cover; and
a tuning sliding member disposed on the one surface of the cover,
wherein a part of the tuning sliding member overlaps with the dielectric area.

12. The RF filter of claim II, further comprising:
cavities defined by walls in the housing member; and
resonators located in the cavities,
wherein a first hole and a second hole are formed on a part of the tuning sliding member, the tuning sliding member slides with supported by the first tuning element through the first hole, and cross coupling amount between corresponding resonators or transmission zero are varied depending on an overlap area of the tuning sliding member and the dielectric area.

13. The RF filter of claim 11, further comprising:
cavities defined by walls in the housing member; and
resonators located in the cavities,
wherein the tuning sliding member slides with disposed on the first tuning element, and cross coupling amount between corresponding resonators or transmission zero are varied depending on an overlap area of the tuning sliding member and the dielectric area.

14. The RF filter of claim 11, wherein the cover is formed by coating conductive material on a dielectric member, the first tuning area and the second tuning area are formed by etching a part of the one surface of the cover, and the tuning sliding member is made up of dielectric material.

15. The RF filter of claim 11, wherein at least one of the first tuning element and the second tuning element moves up and down, each of the first tuning element and the second tuning element is a bolt, the first tuning element is fixed to the one surface of the cover by a first nut, and the second tuning element is fixed to the one surface of the cover by a second nut,
the first tuning element and the second tuning element are disposed symmetrically on the basis of specific wall, and a groove is formed on an upper surface of the wall.
